(19) United States
(12) Patent Application Publication
(10) Pub. No.: US 2009/0177458 A1
(43) Pub. Date: Jul. 9, 2009

(54) SYSTEMS AND METHODS FOR SOLAR MAPPING, DETERMINING A USABLE AREA FOR SOLAR ENERGY PRODUCTION AND/OR PROVIDING SOLAR INFORMATION

(75) Inventors: Steven E. Hochart, Kaneohe, HI (US); Ryan C. Miller, Albuquerque, NM (US); Nigel H. Nugent, Fallbrook, CA (US); Stephanie A. Stoppenhagen, Portland, OR (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: CH2M Hill, Inc., Englewood, CO (US)

(21) Appl. No.: 12/141,795

(22) Filed: Jun. 18, 2008

Related U.S. Application Data
(60) Provisional application No. 60/945,084, filed on Jun. 19, 2007.

(51) Int. Cl. G06G 7/48; G06F 3/00; G06F 7/06; G06F 17/30

(52) U.S. Cl. 703/18; 715/760; 707/10; 707/E17.032

(57) ABSTRACT

A method of determining usable area of a structure for solar energy production may include obtaining a three-dimensional model of a structure and obstructions associated therewith, and performing a shading analysis using the obtained three-dimensional model to obtain a usable area of the structure. A method of providing solar information for a structure using a Web portal may include providing an interactive map, receiving a user selection of a structure located on the interactive map, and providing solar information for the selected structure, wherein the solar information is based at least in part on a usable area obtained by performing a shading analysis using a three-dimensional model of the structure and obstructions associated therewith. A system for providing an interactive Web portal may include a database including solar information regarding a structure, and a server configured to access the database to retrieve the solar information and provide the Web portal.

### CROSS-REFERENCE TO RELATED APPLICATIONS

This application claims the benefit under 37 C.F.R. § 119(e) to U.S. Provisional Patent Application No. 60/945,084, filed Jun. 19, 2007 and entitled “Systems and Methods for Solar Mapping”; the disclosure of which is hereby incorporated herein in its entirety.

### TECHNICAL FIELD

This application relates generally to solar mapping, to providing estimates regarding solar energy installation, and to providing other information related to solar energy installation. This application also relates to a Web portal for solar mapping and providing such information.

### BACKGROUND

Websites are well known for providing mapping information and providing user interactivity, for example, to find locations and/or obtain directions. Many of such websites incorporate traditional street mapping, aerial images and “hybrid” combinations thereof.

Solar energy is a renewable resource that is increasingly important. Solar energy, especially as compared to energy from fossil fuels, is generally known to provide distinct advantages. In addition to being renewable, solar energy does not result in emissions that adversely affect human health and the environment.

### SUMMARY

There is a need for increased awareness of solar energy. There is also a need to help promote increased use of solar energy. Such increased awareness and use may dramatically improve various domestic and global issues related to the environment, energy production and consumption, and human health.

One approach contemplated is a Web portal that provides information regarding solar energy. The Web portal may be implemented as a solar mapping website that provides estimates regarding solar energy installation. In particular, the Web portal may combine known mapping techniques, such as street mapping and aerial images, used to generate a map with the ability to calculate information regarding solar potential of locations on the map. In some embodiments, the Web portal may also incorporate three-dimensional (3D) modeling technology for the calculations.

In some embodiments, solar mapping may be provided by a Web portal to display solar energy potential for structures, such as commercial and residential buildings. The Web portal may also display potential monetary savings derived from solar energy. For example, the Web portal may be associated with a particular entity, such as a city or its government body to provide estimates of the solar energy potential for commercial and/or residential rooftops within the city or other defined area. The Web portal may also display potential environmental benefits from installing a solar energy system on a given property.

The Web portal may use existing technology, such as Google Maps, as a visualization platform. The Web portal may enable users to enter an address and have an aerial view of that address displayed. Users may interact with the Web portal to display information, such as:

an estimate of an amount of solar energy that may be installed on the roof of a given building;

an estimate of an amount of solar energy that may be generated at that site;

an estimate of potential electricity cost reduction resulting from solar installation;

an estimate of the cost of installing a solar system, for example, before and after any state and/or federal incentives;

an estimate of potential carbon dioxide/greenhouse gas (CO2) reduction resulting from solar installation;

one or more case studies of other sites that already have solar systems installed, which may include stories and/or testimonials; and

how to install a solar system, for example, including contact information for local solar installers.

Alternatively or additionally, some embodiments may comprise providing information to educate about solar energy, to identify financial incentives, to facilitate solar energy installation, to increase participation in solar energy, and the like. For example, federal, state and/or local incentives or rebates for investments in a solar energy system may be provided.

Implementations other than a Web portal are also contemplated, and, for example, details described herein may embody solar mapping methodology in any suitable form, such as algorithms, software, hardware or any combination thereof.

Some embodiments may provide a method of determining usable area of a structure for solar energy production. The method may include: obtaining a three-dimensional model of a structure and obstructions associated therewith; and performing a shading analysis using the obtained three-dimensional model to obtain a usable area of the structure.

In some embodiments, the method may also include calculating a solar energy potential for the structure based on the obtained usable area.

In some embodiments, obtaining the three-dimensional model may include obtaining three-dimensional data from stereo photography.

In some embodiments, performing the shading analysis may include performing a time series analysis with a plurality of snapshot images of the structure and obstructions for a corresponding plurality of sun positions. In such embodiments, performing the shading analysis may further include determining usable area on a per pixel basis. In such embodiments, performing the time series analysis may include, for each pixel in each snapshot image, determining whether the pixel receives sunlight. In such embodiments, performing the time series analysis may further include, at least for each pixel that receives sunlight, determining a total number of images in which the pixel receives sunlight. In such embodiments, performing the shading analysis may further include: at least for each pixel that receives sunlight, comparing the total number to a threshold value; determining a number of pixels for which the total number exceeds the threshold; and determining the usable area based on the determined number of pixels.

Some embodiments may provide a method of providing solar information for a structure using a Web portal. The method may include: providing an interactive map; receiving a user selection of a structure located on the interactive map; and providing solar information for the selected structure, wherein the solar information is based at least in part on a usable area obtained by performing a shading analysis using a three-dimensional model of the structure and obstructions associated therewith.

In some embodiments, the solar information provided may include at least one of solar energy potential, electricity production potential, economic savings potential, electricity savings potential, and amount of potential reduction in carbon dioxide production for the selected structure. Alternatively or additionally, the solar information provided may include an identified threshold for the usable area. Also, alternatively or additionally, the solar information provided may include at least one of return on investment and cost options for solar installation on the selected structure.

In some embodiments, receiving a user selection may include receiving an address input by a user. In such embodiments, the method may further include marking the location corresponding to the address on the interactive map.

In some embodiments, the method may further include graphically displaying the usable area on the selected structure.

In some embodiments, the solar information for the selected structure may be stored in a database. In such embodiments, the method may further include providing the solar information comprises accessing the database.

Some embodiments may provide a system for providing an interactive Web portal. The system may include: a database including solar information regarding at least one structure; and a server configured to provide a Web portal including an interactive map to a client device, configured to receive a selection of the at least one structure located on the interactive map from the client device, configured to access the database to retrieve the solar information regarding the at least one structure based on the selection of the at least one structure, and configured to provide the retrieved solar information to the client device.

In some embodiments, the server may be configured to receive the selection as an address input by a user of the client device.

In some embodiments, the solar information included in the database may be based at least in part on a usable area obtained by performing a shading analysis using a three-dimensional model of the structure and obstructions associated therewith.

In some embodiments, the solar information included in the database may include a usable area obtained by performing a shading analysis using a three-dimensional model of the structure and obstructions associated therewith. In such embodiments, the server may be configured to calculate solar information regarding the at least one structure based at least in part on the usable area retrieved from the database and to provide the calculated solar information to the client device.

### BRIEF DESCRIPTION OF THE DRAWINGS

These and other features, aspects and advantages will be more fully understood when considered with respect to the following detailed description, appended claims and accompanying drawings, wherein:

FIG. 1 is flowchart illustrating an example of a method of determining usable area and computing solar energy potential for a structure.

FIG. 2 is a flowchart illustrating an example of a method of performing shading analysis to determine usable area of a structure.

FIG. 3 is a block diagram illustrating an example of a system for providing an interactive Web portal.

FIG. 4 is an example of a main page of a Web portal that may embody various features for solar mapping; and

FIG. 5 is an example of another page of the Web portal that may be accessed via main page of FIG. 4.

### DETAILED DESCRIPTION

Various details are described below, with reference to illustrative embodiments. It will be apparent that the invention may be embodied in a wide variety of forms, some of which may be quite different from those of the disclosed embodiments. Consequently, the specific structural and/or functional details disclosed herein are merely representative and do not limit the scope of the invention.

For example, based on the teachings herein it should be understood that the various structural and/or functional details disclosed herein may be incorporated in an embodiment independently of any other structural and/or functional details. Thus, a system may be implemented and/or a method practiced using any number of the structural and/or functional details set forth herein. Also, a system may be implemented and/or a method practiced using other structural and/or functional details in addition to or other than the structural and/or functional details set forth herein.

Regardless of the particular implementation, embodiments may involve a process for identifying, evaluating and/or ranking potential locations or sites for solar energy installation. In particular, embodiments may provide an efficient and systematic way to evaluate potential sites. For example, evaluation of sites may be performed on a basis of their ability to produce solar energy and/or their ability to produce economic benefit.

Although the methodology described below specifically addresses evaluation of solar photovoltaic (PV) installations, it should be understood that the methodology may be applied to other forms of solar energy, such as thermal heating, cooling or sterling cycle energy production. As such, it should be understood that the methodology may be adapted to a particular application, as appropriate or desired.

An integrated process for evaluation of solar sites may include various elements as described below. It should be understood that the particular order of application of the elements may be varied, as appropriate or desired. Further, application of all elements is not necessary, and other elements may be added, as appropriate or desired, for example, based on future developments.

In general, the process may comprise application of successive elements (layers) of refinement to site evaluation. Upon completion, or at any suitable stage during the process, the energy and/or economic potential of the site may be evaluated, for example, against a reference standard. This may allow a site to be judged for further evaluation and/or consideration.

The methodology may comprise an evaluation process incorporating any or all of the following elements:

1. One or more potential sites may be selected and identified by location on the surface of the earth. For example, photographic images such as those available from “Google Earth” may be employed. The images may be two-dimensional or 3-dimensional, as appropriate or desired. Sites identified may be undeveloped (on ground or water) or developed (such as a roof top of a building).
2. Once identified, a site may initially be evaluated based on the latitude of the site and the area of the site. Algorithms may be employed to calculate the solar potential of the site, for example, based on available incident energy.
3. If three-dimensional information regarding the site is available:

3.1. The site may be further evaluated by algorithms configured to calculate any reduction of solar potential that may occur, for example, due to shadows resulting from solar obstructions such as trees, structures and/or terrain. If trees contribute to the reduction of solar potential, the algorithms may be configured to take into account the type of tree and seasonal variations.

3.2. The site (such as a building roof top or sloping field) may be further evaluated by algorithms that are configured to take into account orientation and/or shape.

4. The site may be evaluated based on algorithms configured to take into account seasonal and/or daily weather patterns, as well as cloud cover, to adjust anticipated solar potential. Such information may be derived, for example, from historical data or from analysis of satellite images. Further, such information may be available from sources such as the Solar Radiation Monitoring Laboratory at the University of Oregon.
5. The site may be evaluated based on various anticipated uses of the energy production. For example:

5.1. An objective may be to maximize total annual production. In such case, the maximum annual integrated solar energy production may be most significant.

5.2. An objective may be to produce energy for specific applications, which may be associated with the site, such as building air conditioning. In such case, the site may be evaluated by algorithms which, for example, are configured to consider the need for air conditioning based on seasonal variations and/or time of day variations.

5.3. An objective may be to obtain peak shaving of the energy grid power. In such case, the site may be evaluated by algorithms which, for example, are configured to consider such elements as time of day, season, other power source availability, etc.

6. The site may be evaluated on an economic basis. For example, algorithms may be employed that are configured to consider the selling price of power which may be generated at the site. Such evaluation may include seasonal, time of day or other rate structures that may impact economic viability.
7. The site may be evaluated, on an energy or economic basis, taking into consideration the type of collection system used, such as PV, fixed mounted or solar tracking.
8. The site may be evaluated using algorithms that take into account capital and/or operation cost of solar systems developed at the site. Such algorithms may be configured to consider (in addition to any of the previously discussed criteria) such information as:

8.1. the area of site;

8.2. any incentives available;

8.3. the proximity of the site to related infrastructure, such as transmission lines or power grid; and/or

8.4. the local markets.

The methodology or process of evaluation may be accomplished, for example, using computer software of various forms. It may be accomplished, for example, by software that is configured to function with an existing product, such as “Google Earth.” Using computer software, for example, via the Internet, a user may select a potential site and evaluate that site by being lead through a process such as above. In such case, the site may be continuously evaluated against criteria to report viability to the user.

The software may be configured to provide recommendations to the user. The site evaluation and associated recommendations may be provided at completion of the evaluation or at any time during the evaluation process. The software may make recommendations, for example, regarding technical and/or economic applications for solar applications on the site, such as collector angle and direction or orientation.

Alternatively or additionally, the user may, for example, be directed to various websites, which may advise the user about products or services related to development of the site for solar applications. Providers of such products or services may pay some type of fee for connection to the user or information about the site under evaluation.

The user may be an entity that evaluates a large number of sites or all sites in a given area for its own purposes or as a contracted service to another entity. Such entities may include a city, a municipality, a state, a developer, a utility or the like.

The software may be configured to predict performance outcomes of a solar installation. Such prediction may include energy and/or economic predictions. Further, the software may be configured to identify potential incentives.

The software may also be configured to project the impact on the site of anticipated future changes, such as: growth of trees, future construction of structures (e.g., buildings); global warming; future incentives; energy prices or rates; future capital and/or operating cost changes, etc.

The software may also be configured to rank potential sites by various criteria.

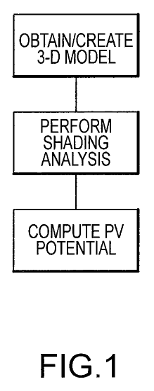

FIG. 1 is flowchart illustrating an example of a method of determining usable area and computing solar energy potential for a structure. As discussed above, some embodiments may provide a method of determining usable area of a structure for solar energy production.

The process may begin with an operation of creating or otherwise obtaining a three-dimensional model of a structure and obstructions associated therewith [BLOCK S110]. As used herein, the term “structure” is meant to encompass any building that may be desirable to consider for a solar energy installation. Similarly, the term “obstructions” or “obstruction” is meant to encompass any structure that may interfere with receipt of sunlight/solar rays. Thus, the obstructions associated with a particular structure/building may include, but are not limited to, structural features of the building including fixtures (such as chimneys, heating and air-conditioning equipment, satellite dishes), other buildings in the vicinity, vegetation (such as trees), and other structures (such as telephone poles, signs, landforms, etc.). Obstructions are considered to be associated with a particular structure/building when they are located sufficiently near the particular structure/building to interfere with receipt of sunlight/solar rays by any portion of the potential usable area of the structure/building for a solar energy installation (e.g., the roof of the structure/building).

The three-dimensional model may be created in any suitable manner. In particular, the three-dimensional model may be created from as-built construction data, survey or measurement data, data obtained from light detection and ranging (LIDAR), oblique aerial photography and/or stereo photography. For example, heights may be calculated from oblique or stereo photography. However, it has been found that stereo photography may be more accurate.

Once the three-dimensional model is available, an operation of performing a shading analysis using the three-dimensional model may be executed to obtain a usable area of the structure [BLOCK S120]. The shading analysis may be performed by any suitable computational method, and may be performed to any suitable or desired degree of accuracy. For example, the shading analysis may be performed as a time series analysis with a plurality of snapshot images of the structure and associated obstructions for a corresponding plurality of sun positions. Alternatively, a plurality of light sources representing the sun at different times and/or dates may be employed to calculate shadow angles of rooftop obstructions and estimate the areas receiving direct solar radiation throughout the year.

Once the shading analysis has been performed and the usable area of the structure has been determined, a photo-voltaic (PV) potential or solar energy potential may be computed or calculated for the structure based on the usable area [BLOCK S130]. It should be understood that such PV potential or solar energy potential is an “ideal” value that may provide input to other tool or algorithms for computing or calculating other solar information. Further, it should be understood that PV or solar energy potential is only one example of solar information that may be calculated based on the usable area. For example, the useable area may also be used with tools such as Clean Power Estimator™ or PVWATTS to model electricity production.

As discussed above, in some embodiments performing the shading analysis may include performing a time series analysis with a plurality of snapshot images of the structure and obstructions for a corresponding plurality of sun positions. This may involve determining usable area on a per pixel basis.

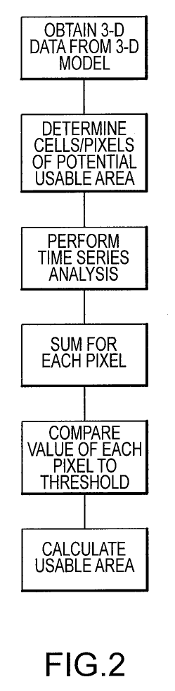

FIG. 2 is a flowchart illustrating such an example of a method of performing shading analysis to determine usable area of a structure. The process may begin with an operation of obtaining a three-dimensional data from the three-dimensional model [BLOCK S210]. Next, an operation of determining cells or pixels of the potential usable area may be performed [BLOCK S220]. It should be understood that the potential usable area may be defined by usable roof space of the particular structure/building, that is, the area of the roof that is not already occupied by a structural feature or fixture of the structure/building. It should also be understood that the size of a cell or pixel may be determined as appropriate or desired. For example, software and/or hardware may dictate pixel size or may allow a user to determine cell/pixel size for a desired level of accuracy.

Once the pixels of the potential usable area have been determined, an operation of performing a time series analysis may be executed [BLOCK S230]. The time series analysis may be for any suitable or desired time series. For example, the analysis may conveniently encompass a single year, with a desired number of snapshots to sample the sunlight received by pixels throughout the year. Thus, the snapshots may be, for example, monthly, weekly, daily, hourly, etc. Further, the snapshots may be only for daylight hours. Other increments may be selected for the snapshots as well. Possibly even non-periodic and/or random snapshots may be employed, as appropriate or desired. Regardless of the number and temporal placement of the snapshots, for each pixel in each snapshot image, a determination may be made whether the pixel receives sunlight from the sun position for that snapshot image.

Then, at least for each pixel that receives sunlight, an operation of summing the number of snapshots in which the pixel receives sunlight or otherwise determining a total number of images in which the pixel receives sunlight may be performed [BLOCK S240]. For example, if the time series analysis involves weekly snapshots, the total possible number of images in which a given pixel receives sunlight is 52. Thus, the sum for each pixel would range from zero to 52. It should be understood that the summing/determining may be performed in any suitable manner. For example, a binary approach of assigning values zero (receiving no sunlight) or one (receiving sunlight) to each pixel in each snapshot image may provide a convenient way.

The total number of snapshots in which a given pixel receives sunlight thus provides a value for that pixel. An operation of comparing this value of each pixel to a threshold may then be performed [BLOCK S250]. The threshold may be set as appropriate or desired, such as 80 percent, 90 percent or the like. For example, the threshold may be set based on a predetermined “cutoff” for solar installations generally or for a particular solar installation. The “cutoff” may be determined based on the minimum amount of sunlight a solar installation must receive for economic feasibility, for example. Thus, the pixel values may be compared to the threshold to determine in they exceed the threshold and should be considered suitable for a solar installation. It should be understood that meeting the threshold may be sufficient, as it is merely a matter of selecting the threshold (i.e., exceeding a threshold of 79.9 percent may be sufficiently equivalent to meeting or exceeding a threshold of 80 percent).

Thus, an operation of calculating the usable area may be performed using the pixels with values that meet and/or exceed the threshold [BLOCK S260]. It should be understood that multiple thresholds may be employed to generate a plurality of corresponding usable areas for the particular structure/building. Thus, depending on the minimum amount of sunlight that is acceptable for a particular solar installation or a particular person, multiple usable area values may be provided for evaluation.

Alternatively to the per pixel basis described with respect to FIG. 2, a vector based approach may be employed. For example, similar to above, a time series analysis with a plurality of snapshot images of the structure and obstructions for a corresponding plurality of sun positions may be performed. Common areas that receive. sunlight in all or most images, depending on the threshold set, may determine the usable area.

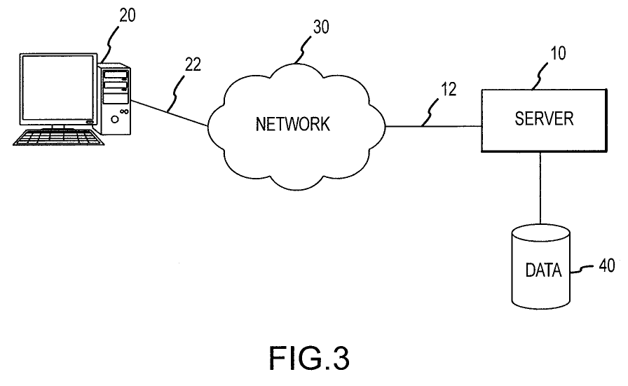

As discussed above, some embodiments may provide a method of providing solar information for a structure using a Web portal, and some embodiments may provide a system for providing an interactive Web portal. FIG. 3 is a block diagram illustrating an example of such a system, which may also be configured to perform such a method.

The system may include a server 10 configured to provide a Web portal including an interactive map to a client device 20 via a network 30, such as the Internet. The server 10 should be understood to be any suitable computing device capable of providing an interactive website or portal. Similarly, the client device should be understood to be any suitable computing or interface device, such as a personal computer, cell phone, personal digital assistant, or other device capable of displaying a website or portal and facilitating user interaction therewith. A communication link 12 between the server 10 and the network 30 and a communication link 22 between the client device 20 should be understood to be any suitable wired or wireless connection that allows and/or facilitates communication of data.

The system may further include a database 40 including solar information regarding at least one structure. In some embodiments, the solar information included in the database 40 may be based at least in part on a usable area obtained by performing a shading analysis using a three-dimensional model of the structure and obstructions associated therewith.

The server 10 may be configured to receive a selection of the at least one structure located on the interactive map from the client device 20. In particular, the server 10 may be configured to receive the selection as an address input by a user of the client device 20. Based on the selection of the at least one structure, the server 10 may access the database 20 to retrieve the solar information regarding the at least one structure. The server 10 may then provide the retrieved solar information to the client device 20.

In other embodiments, the solar information included in the database 40 may include a usable area obtained by performing a shading analysis using a three-dimensional model of the structure and obstructions associated therewith. In such embodiments, the server 10 may be configured to calculate solar information regarding the at least one structure based at least in part on the usable area retrieved from the database 40. Then, the server 10 may provide the calculated solar information to the client device 20.

Although a single client device 20, a single network 20, a single server 10 and a single database 40 are illustrated in FIG. 3, it should be understood that a plurality of such elements may be employed as appropriate or desired. Further, it should be understood that FIG. 3 is only a high-level example of a system, and that various implementations may be envisioned that employ additional and/or other elements to perform such functions. Is should also be understood that any of the functions described herein may be implemented as will be readily understood from this high-level example and the additional descriptions of such functions.

Thus, the system of FIG. 3 may be configured to: provide an interactive map; receive a user selection of a structure located on the interactive map; and provide solar information for the selected structure, wherein the solar information is based at least in part on a usable area obtained by performing a shading analysis using a three-dimensional model of the structure and obstructions associated therewith. The solar information provided by the system may include at least one of solar energy potential, electricity production potential, economic savings potential, electricity savings potential, and amount of potential reduction in carbon dioxide production for the selected structure. Alternatively or additionally, the solar information provided by the system may include an identified threshold for the usable area. Also, alternatively or additionally, the solar information provided by the system may include at least one of return on investment and cost options for solar installation on the selected structure.

The system may be configured to receive the user selection as an address input by a user. In such embodiments, the system may be configured to mark the location corresponding to the address on the interactive map. The system may, alternatively or additionally, be configured to graphically display the usable area on the selected structure.

The following description sets forth illustrative examples of pages that may be provided by a Web portal for solar mapping, for example, a Web portal as provided by the system of FIG. 3 and/or a Web portal involving some or all of the processes of FIGS. 1 and 2. It should be understood that other presentations, layouts, interfaces, etc. may be used and that the description below is given to assist in understanding the details described herein. As such, the pages shown are not intended to be limiting of the embodiments that may be envisioned.

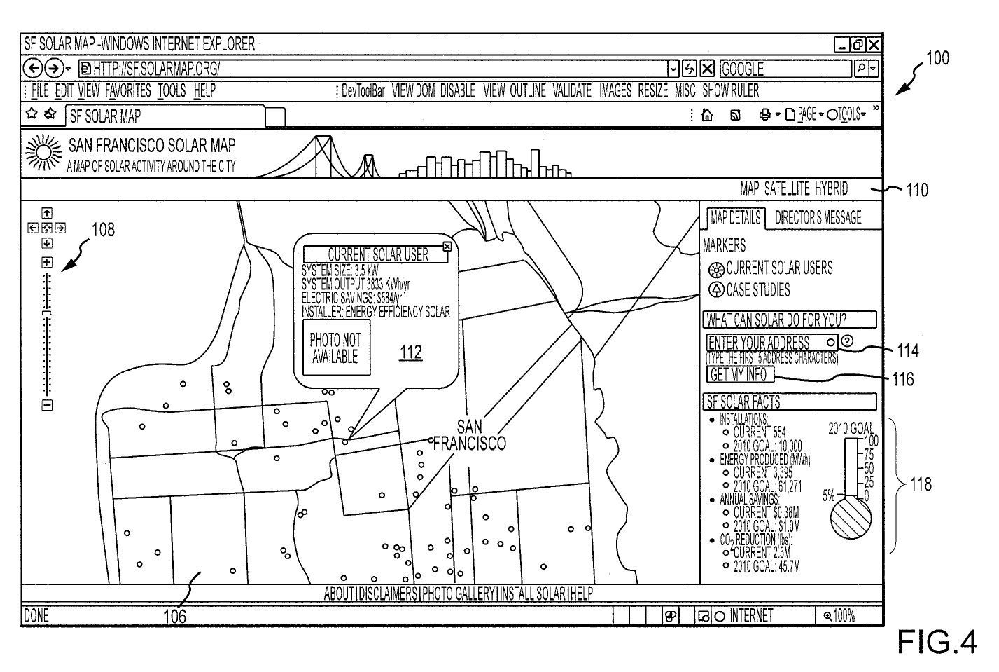

FIG. 4 shows an example of a main page 100 of a Web portal that may embody various features for solar mapping. The Web portal may be configured to provide any of the foregoing features detailed above. For example, the Web portal may be associated with a municipality, such as San Francisco, or any other entity. Further, the Web portal may be associated with another entity, such as CH2MHILL, for example, as the provider of technology employed by the Web portal. Links 102, 104 may be provided to information regarding such entities, such as their involvement with solar energy and/or the environment.

The Web portal may display an interactive map 106 that provides a user with similar capabilities of zooming and panning 108, and may provide viewing options 110, such as street mapping, satellite images and hybrid mapping. The Web portal may also display various information regarding the area depicted by the interactive map 106. For example, the Web portal may display information 118 regarding current installations, energy production, energy savings, environmental impact, such as reduction of carbon dioxide emissions, and goal for solar development. Such information may be periodically updated to account for increases in installations or other changes.

Various interactive markers may be displayed on the interactive map 106, such as current solar installations, case studies and/or sites being evaluated. The interactive markers may allow a user to select a location. Upon selection of the location, more information, such as details of the solar system and any evaluations thereof, may be displayed to the user, for example, as an information bubble 112.

The user may also be able to select a site for evaluation, for example, by clicking on a location of the map or by entering an address, for example, in an input box 114. The user may then obtain information regarding the site corresponding to the address, for example, by selecting a button 116.

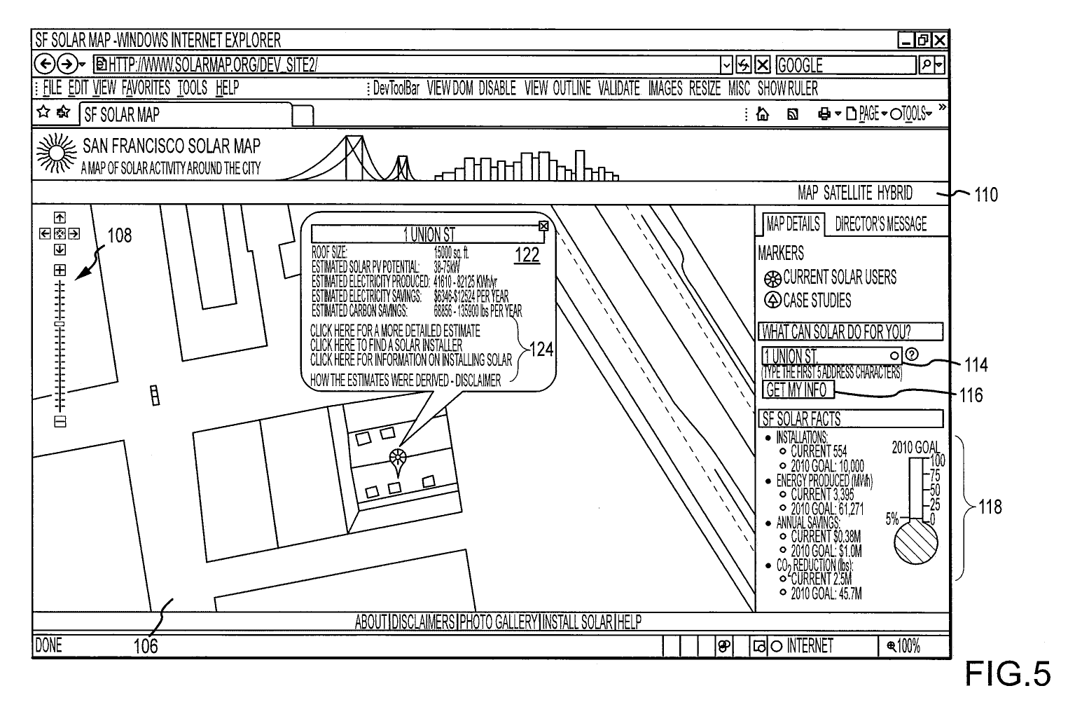

FIG. 5 is an example of another page 120 that may be accessed via the main page of FIG. 1, for example, by entering an address and selecting the button 116. In such case, the map may automatically zoom or otherwise change to display details of the selected site, such as the roof top where a solar installation would be made. Further, more information, such as details of the site and its solar potential, may be displayed to the user, for example, as another information bubble 122. The Web portal may also provide links 124 to further information, for example, in the information bubble 122. The links 124 may be to another website, another webpage, a pop-up window or the like, and may relate to how the estimates for evaluating the site were derived, etc.

Sites selected for evaluation may be marked and tracked, as appropriate or desired. For example, the evaluation sites may be updated each time the user visits the Web portal to provide an ongoing evaluation of potential sites.

Embodiments of the Web portal and/or the methodology described herein may be implemented as a business venture between a service provider, such as CH2MHILL, and a city, government, or other similar entity. For example, the service provider may, for example, for a monthly fee (dependant on the accuracy of existing data), host a Web portal. The service provider may create a solar mapping system for the city, for example, and develop or build the Web portal. The service provider may, for example, integrate the Web portal with the existing website of the city. The service provider may also manage and update the Web portal as desired.

Alternatively, the city may host a Web portal. The service provider may provide consulting services to the city, for example, by establishing a consulting agreement. The service provider may create or assist with creating a city solar mapping system and/or build or help build the Web portal, depending on the consulting agreement. The service provider may integrate or help integrate the Web portal with the existing website of the city, and may provide an annual update and/or maintenance as desired.

Embodiments of the Web portal and/or the methodology described herein may be implemented as a business service to a client by a service provider, such as CH2MHILL. This may be approached similarly to the foregoing, with either the client or the service provider hosting a Web portal. The service provider may develop a solar mapping system, for example, and develop or build the an “intranet” Web portal for the client. Via the Web portal, the service provider may provide Web-based GIS (geographical information system), mapping of all buildings of the client, provide analysis of solar potential for each building, enable site selection to fully benefit from solar energy, and/or provide auditable reports regarding the client's renewable energy compliance, for example, as may be required by the government.

Additionally, the service provider may provide full solar energy implementation for the client. This may include, for example, providing full program management to install solar energy equipment, site selection analysis to identify most suitable buildings, solar panel manufacturer analysis and selection, installation and contractor management and/or on going support, servicing and maintenance.

In general, the Web portal may be backed by a database including usable area assessments for every building located on an interactive map, for example, a city-wide map with corresponding usable area assessments for every building. Alternatively, the assessments may be limited to commercial buildings, public/government buildings, residential buildings or any other desired subset.

In particular, one embodiment envisioned is to provide a database with single building assessments. Although a plurality of single building assessments may be included, the database would not be automatically populated with assessments for every building or every building of a given subset. Rather, a single individual could request an assessment of a particular building, such as his residence. The assessment may be performed for example, either by a solar installer or by a third party at the request of the solar installer, and have a passcode associated with the assessment. The individual may be provided with the passcode and then be able to access the assessment by visiting a Web portal and entering the passcode to receive the usable area information and/or other solar information based on the usable area for his residence. The Web portal may be associated with the third party, or may be “branded” to be associated with the solar installer.

While certain exemplary embodiments have been described above in detail and shown in the accompanying drawings, it is to be understood that such embodiments are merely illustrative of and not restrictive of the broad invention. In particular, it should be recognized that the teachings provided herein apply to a wide variety of systems and processes. It will thus be recognized that various modifications may be made to the illustrated and other embodiments described herein, without departing from the broad inventive scope thereof. In view of the above it will be understood that the invention is not limited to the particular embodiments or arrangements disclosed, but is rather intended to cover any changes, adaptations or modifications which are within the scope and spirit of the disclosure provided herein.

What is claimed is:

1. A method of determining usable area of a structure for solar energy production, the method comprising:
obtaining a three-dimensional model of a structure and obstructions associated therewith; and
performing a shading analysis using the obtained three-dimensional model to obtain a usable area of the structure.

2. The method of claim 1, further comprising calculating a solar energy potential for the structure based on the obtained usable area.

3. The method of claim 1, wherein obtaining the three-dimensional model comprises obtaining three-dimensional data from stereo photography.

4. The method of claim 1, wherein performing the shading analysis comprises performing a time series analysis with a plurality of snapshot images of the structure and obstructions for a corresponding plurality of sun positions.

5. The method of claim 4, wherein performing the shading analysis further comprises determining usable area on a per pixel basis.

6. The method of claim 5, wherein performing the time series analysis comprises, for each pixel in each snapshot image, determining whether the pixel receives sunlight.

7. The method of claim 6, wherein performing the time series analysis further comprises, at least for each pixel that receives sunlight, determining a total number of images in which the pixel receives sunlight.

8. The method of claim 7, wherein performing the shading analysis further comprises:
at least for each pixel that receives sunlight, comparing the total number to a threshold value;
determining a number of pixels for which the total number exceeds the threshold; and
determining the usable area based on the determined number of pixels.

9. A method of providing solar information for a structure using a Web portal, the method comprising:
providing an interactive map;
receiving a user selection of a structure located on the interactive map; and
providing solar information for the selected structure, wherein the solar information is based at least in part on a usable area obtained by performing a shading analysis using a three-dimensional model of the structure and obstructions associated therewith.

10. The method of claim 9, wherein the solar information provided comprises at least one of solar energy potential, electricity production potential, economic savings potential, electricity savings potential, and amount of potential reduction in carbon dioxide production for the selected structure.

11. The method of claim 9, wherein the solar information provided comprises an identified threshold for the usable area.

12. The method of claim 9, wherein the solar information provided comprises at least one of return on investment and cost options for solar installation on the selected structure.

13. The method of claim 9, wherein receiving a user selection comprises receiving an address input by a user.

14. The method of claim 13, further comprising marking the location corresponding to the address on the interactive map.

15. The method of claim 9, further comprising graphically displaying the usable area on the selected structure.

16. The method of claim 9, wherein the solar information for the selected structure is stored in a database, and providing the solar information comprises accessing the database.

17. A system for providing an interactive Web portal, the system comprising:
a database including solar information regarding at least one structure; and
a server configured to provide a Web portal including an interactive map to a client device, configured to receive a selection of the at least one structure located on the interactive map from the client device, configured to access the database to retrieve the solar information regarding the at least one structure based on the selection of the at least one structure, and configured to provide the retrieved solar information to the client device.

18. The system of claim 17, wherein the server is configured to receive the selection as an address input by a user of the client device.

19. The system of claim 17, wherein the solar information included in the database is based at least in part on a usable area obtained by performing a shading analysis using a three-dimensional model of the structure and obstructions associated therewith.

20. The system of claim 17, wherein the solar information included in the database comprises a usable area obtained by performing a shading analysis using a three-dimensional model of the structure and obstructions associated therewith.

21. The system of claim 20, wherein the server is configured to calculate solar information regarding the at least one structure based at least in part on the usable area retrieved from the database and to provide the calculated solar information to the client device.

22. A method of solar mapping using a Web portal, the method comprising:
providing an interactive map;
receiving a user selection of a location on the interactive map; and
providing an estimate of at least one of solar energy potential, economic savings potential, electricity savings potential, and amount of potential reduction in carbon dioxide production for the selected location.

23. The method of claim 22, wherein receiving a user selection comprises receiving an address input by a user.

24. The method of claim 23, further comprising displaying a location of at least one existing solar installation.

25. The method of claim 24, further comprising displaying information regarding the existing solar installation upon receiving a user selection of the location of the existing solar installation.

26. The method of claim 22, further comprising displaying at least one of a total number of existing solar installations displayed on the interactive map, a combined amount of energy production for existing solar installations displayed on the interactive map, a combined amount of economic savings for existing solar installations displayed on the interactive map, a combined amount of electricity savings for existing solar installations displayed on the interactive map, and a combined amount of reduction in carbon dioxide production for existing solar installations displayed on the interactive map.

27. The method of claim 22, further comprising displaying a goal of at least one of a total number of existing solar installations displayed on the interactive map, a combined amount of energy production for existing solar installations displayed on the interactive map, a combined amount of economic savings for existing solar installations displayed on the interactive map, a combined amount of electricity savings for existing solar installations displayed on the interactive map, and a combined amount of reduction in carbon dioxide production for existing solar installations displayed on the interactive map.

28. The method of claim 27, further comprising displaying progress toward the displayed goal.

29. The method of claim 22, further comprising providing a link to information regarding at least one solar installer local to the selected location.

30. The method of claim 22, further comprising providing a link to a website that provides a more detailed estimate of at least one of solar energy potential, electricity production potential, economic savings potential, electricity savings potential, and amount of potential reduction in carbon dioxide production for the selected location.

31. The method of claim 22, further comprising providing a link to information regarding solar installation.

32. The method of claim 22, further comprising providing a link to information regarding how the at least one estimate was derived.

33. The method of claim 22, wherein the interactive map is of at least one of a municipality, a township, a county, a state, a province, a territory and a country.
